(19) United States
(12) Patent Application Publication
(10) Pub. No.: US 2008/0297706 A1
(43) Pub. Date: Dec. 4, 2008

(54) LIQUID CRYSTAL DISPLAY PANEL AND MANUFACTURING METHOD THEREOF

(75) Inventor: De-Jiun LI, Padeh City (TW)

Correspondence Address: Muncy, Geissler, Olds & Lowe, PLLC, P.O. BOX 1364, FAIRFAX, VA, 22038-1364, US

(73) Assignee: CHUNGHWA PICTURE TUBES, LTD.

(21) Appl. No.: 12/129,311

(22) Filed: May 29, 2008

(30) Foreign Application Priority Data
Jun. 1, 2007 (TW) 96119630

(51) Int. Cl. G02F 1/1335

(52) U.S. Cl. 349/106

(57) ABSTRACT

With the pattern modification of a white color layer, a liquid crystal display panel is provided with a part of transparent layer overlapped with a color layer, such that a color layer is implemented with different thickness. Such a color filter substrate applied on a liquid crystal display panel enhances the problem of a viewing-angle color shift.

### BACKGROUND OF THE INVENTION

1. Field of the Invention

The present invention relates to a liquid crystal display panel and the manufacturing method thereof, and more especially, to the liquid crystal display panel with four color layers.

2. Background of the Related Art

For a multi-domain vertical alignment (MVA) liquid crystal display (LCD) panel, a color shift in different viewing-angle causes the degradation of display qualities. Thus, it is important to resolve the problem of the color shift on the MVA LCD panel. One of conventional resolution on color shift is to modify the design of a pixel electrode in which there are different voltages imposed on a pixel unit to cause the different twisting angles of liquid crystal molecules. Another resolution is to form the folding patterns on pixel electrodes and common electrodes respectively to cause a scattering field for reducing the color shift.

On the other hand, the method of manufacturing multi-domain with a multi-cell gap is applied to the MVA LCD panel. Shown in FIG. 1 is a schematic cross-sectional diagram illustrating an MVA LCD panel 10 in accordance with one prior art. Two substrates 102 and 104 are in parallel. A plurality of thin film transistors (not shown) are electrically connected pixel electrodes 106 disposed on the substrate 104. A color layer 108 and a plurality of common electrodes 110 are disposed on the substrate 102. A liquid crystal layer is sandwiched (not shown) between the substrates 102 and 104. Each of the pixel regions of the color layer 108 is divided into two sub-regions present with the marks “B” and “C” in FIG. 1. An organic layer 120 is disposed on the common electrodes 110 within the sub-region “B”, which makes different cell gaps in the sub-regions “B” and “C”. The liquid crystal molecules within the sub-regions “B” and “C” are twisted in different angles under the same electric field. Thus, the color shift may be reduced because of the existence of the multi-cell gap.

However, it is necessary for the LCD panel 10 to be implemented by additional steps and materials for forming a multi-cell gap design aforementioned. Thus, it is one of important issues on the manufacture of the multi-cell gap with the cost down and simplified steps.

### SUMMARY OF THE INVENTION

One of objects of the present invention provides the design of a LCD panel and the manufacturing method thereof. The LCD panel is in the different thickness by forming the transparent white color layer partially overlapped the other color layers.

Another object of the present invention provides a LCD panel and the manufacturing method thereof by changing the mask pattern of the transparent white color layer without additional steps or structures.

Another object of the present invention provides a LCD panel and the manufacturing method thereof. The green, blue or red color layer is provided with at least two different thickness to form multi cell gaps.

Accordingly, a LCD panel includes a first substrate and a second substrate disposed face to face with the first substrate. A black matrix is disposed on the first substrate and defines a plurality of sub-pixels. A patterned transparent layer is disposed on the sub-pixels and a patterned color layer disposed on the sub-pixels to cover a part of the patterned transparent layer.

Accordingly, a method of manufacturing a LCD panel includes providing a first substrate and a second substrate disposed face to face the first substrate. A black matrix is formed on the first substrate to define a plurality of sub-pixels. A patterned color layer is formed on the sub-pixels and a patterned transparent layer is formed on the sub-pixels and covering a part of the color layer.

### BRIEF DESCRIPTION OF THE DRAWINGS

FIG. 1 is a schematic cross-sectional diagram illustrating an MVA LCD panel in accordance with one prior art.

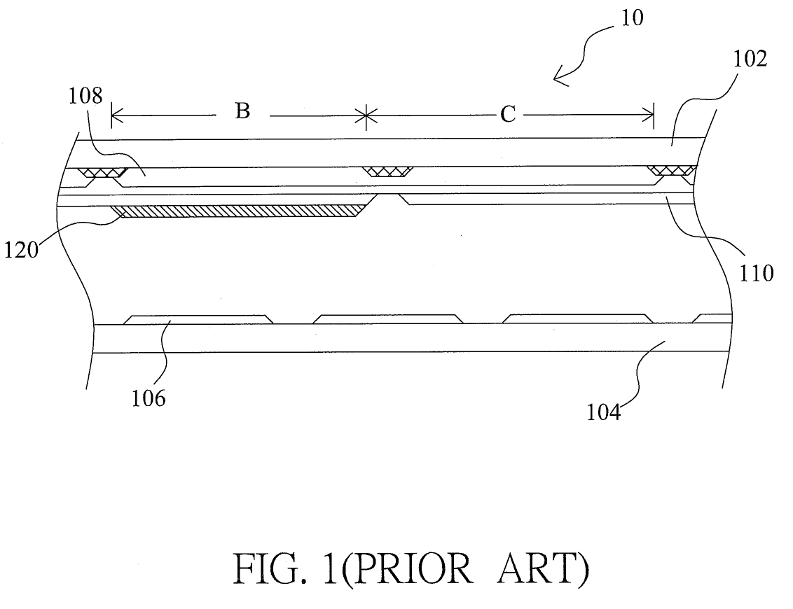

FIG. 2 is a schematic cross-sectional diagram illustrating an MVA LCD panel in accordance with one embodiment of the present invention.

FIG. 3 is a schematic cross-sectional diagram illustrating manufacturing a structure in accordance with one embodiment of the present invention.

FIG. 4 is a schematic cross-sectional diagram illustrating manufacturing a structure in accordance with another embodiment of the present invention.

### DETAILED DESCRIPTION OF THE INVENTION

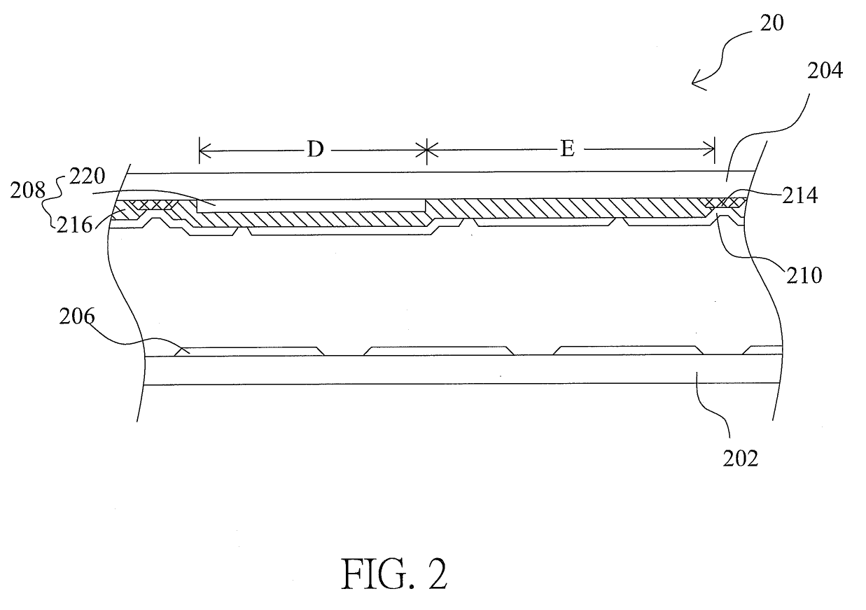

FIG. 2 is a schematic cross-sectional diagram illustrating an MVA LCD panel 20 in accordance with one embodiment of the present invention. A first substrate 204 and a second substrate 202 are in parallel and separated from each other by a gap. The first substrate 204 or the second substrate 202 may be a glass or transparent insulating substrate. A liquid crystal layer (not shown) is sandwiched between the first substrate 204 and the second substrate 202. In an embodiment, the first substrate 204, such as a color filter substrate, is provided with a color layer 208 and a conductive layer 210. The conductive layer 210 is made of a transparent conductive material, such as ITO (Indium Tin Oxide) or IZO (Indium Zinc Oxide), on the color layer 208 and configured for a common electrode. On the other hand, the second substrate 202, such as a TFT array substrate, includes a conductive layer 206 which is made of a transparent conductive material, such as ITO or IZO, and forms a protrusion or a slit configured for a transparent pixel electrode electrically connected to a TFT (not shown). Moreover, a black matrix 214 is distributed among a patterned color layer 216 and configured for preventing light leakage. In the embodiment, a pixel unit of the LCD panel 20 includes R, G, B and W color sub-pixels defined by the black matrix 214. Shown in FIG. 2, each monochromatic patterned color layer 216 includes the region “D” and the region “E”. A patterned transparent layer 220 is disposed within the region “D” to cause the different thickness in the region “D” and the region “E”. The different cell gaps cause the liquid crystal molecules to be twisted in the different angles under an identical electrical field. Such a multi-domain LCD panel within the pixel unit may reduce the viewing-angle color shift.

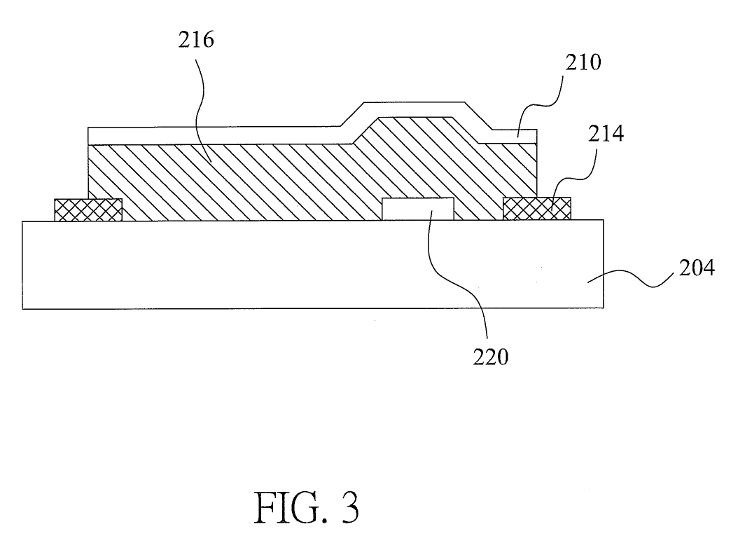

Shown in FIG. 3 is a schematic cross-sectional diagram illustrating manufacturing a structure for reducing the viewing-angle color shift in accordance with one embodiment of the present invention. In the first embodiment, the black matrix 214 kept a space from each another is formed on the first substrate 204 by any suitable method. A patterned transparent layer 220 is formed on the first substrate 204 and is separated from the black matrix 214. Then a patterned color layer 216 covers a part of surface of the black matrix 214 and the patterned transparent layer 220. In the first embodiment, the black matrix 214 is implemented by, but not limited to, such as the method of a thin metal film, mixing pigment, resin black matrix or lithography from a back side, etc. In addition to covering the surface among the black matrix 214, the patterned transparent layer 220 includes the pattern of white color sub-pixels for a four-color (RGBW) display. Thus, according to the spirit of the present invention, without the addition of any process or structure, the patterned transparent layer 220 is implemented by modifying the mask pattern of a white color transparent layer. Furthermore, the size or geometric shape of the patterned transparent layer 220 is not limited as long as it may cause a profile with different thickness. Moreover, the patterned color layer 216 may be the color layer of red, green or blue, which is not limited to geometric shapes, sizes of alignment. Furthermore, a transparent conductive structure 210 is formed on the patterned color layer 216 to be as a common electrode. It is appreciated that one or more slots or cutouts in the transparent conductive structure 210, ITO or IZO layer, are associated with the protrusions to control the twist angles of the liquid crystal molecules.

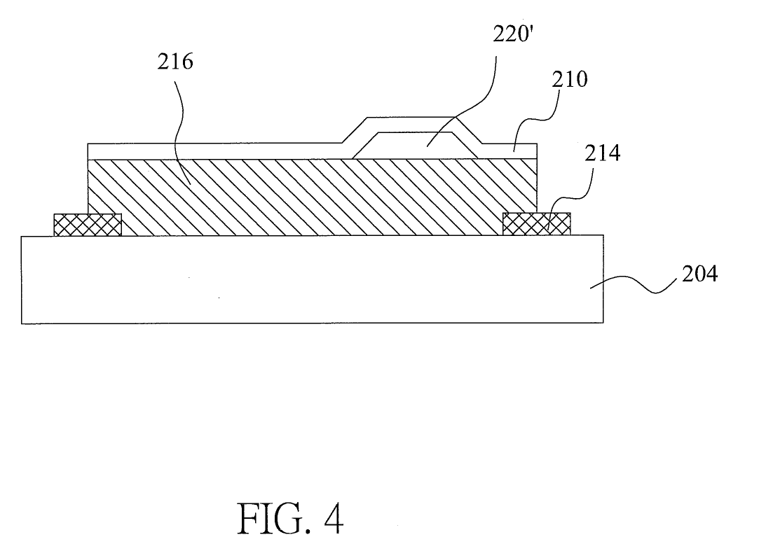

FIG. 4 is a schematic cross-sectional diagram illustrating manufacturing a structure for reducing the viewing-angle color shift in accordance with another embodiment of the present invention. Difference between the first embodiment and the second embodiment is that the patterned color layer 216 is formed to cover both the part of the black matrix 214 and the exposed surface of the second substrate 204 among the black matrix 214, after the forming step of the black matrix 214 on the first substrate 204. Then the patterned transparent layer 220′ is formed thereon.

Accordingly, the patterned transparent layer 220′ or 222 may be formed alternatively before or after the forming of the patterned color layer 216. In both cases aforementioned, the surface profile of a LCD panel would be with the different thickness.

Accordingly, the patterned color layer of red, green and blue color and the patterned transparent layer may be in any geometric shape and size to meet the requirement of the LCD panel 20. For example, the patterned color layer of a single sub-pixel is divided into two regions by bumps and slits. One region of the patterned color layer is not overlapped with the patterned transparent layer. The other region of the patterned color layer is overlapped with the patterned transparent layer. Thus, the patterned color layer of a single sub-pixel provided with the different thickness enhances the viewing-angle color shift on an MVA LCD panel 20.

Accordingly, the present invention provides a white color layer to make a single pixel with the cell gaps in different spaces by adding the pattern of protrusion into the mask pattern of a white color filter, which needs neither additional masks nor other additional structures. The method and structure are applied to, such as the type of color layer/bump-array/ITO-slit or the type of color layer/bump-array/bump for manufacturing multi-domain of a single pixel, or to various pixel types, such as patterned vertical alignment (PVA), advanced MVA or advanced super view (ASV), etc. Compared with one display in use of various voltages for controlling the twisting angles of the liquid crystal molecules, or other with an organic layer implemented in use of additional masks materials or manufacturing steps, the LCD panel with the multi-domain design of the present invention is implemented by cost-down and simplified steps. Moreover, the color layer of the present invention provided with four color layers in a LCD panel may generate the display with a high gray level and be applied to any billboard in airports or train stations, etc.

Although the present invention has been explained in relation to its preferred embodiment, it is to be understood that other modifications and variation can be made without departing the spirit and scope of the invention as hereafter claimed.

What is claimed is:

1. A liquid crystal display panel, comprising:
a first substrate;
a black matrix disposed on the first substrate and defining a plurality of sub-pixels;
a patterned transparent layer disposed on the sub-pixels;
a patterned color layer disposed on the sub-pixels and covering the patterned transparent layer; and
a second substrate disposed face to face with the first substrate.

2. The liquid crystal display panel according to claim 1, further comprising a liquid crystal layer disposed between the first substrate and the second substrate.

3. The liquid crystal display panel according to claim 1, wherein the patterned transparent layer comprises a white color layer.

4. The liquid crystal display panel according to claim 1, wherein the patterned color layer comprises one color of red, green, and blue.

5. The liquid crystal display panel according to claim 1, wherein the second substrate comprises a conductive layer.

6. The liquid crystal display panel according to claim 1, wherein any of the sub-pixels comprises a red, a green or a blue regions.

7. The liquid crystal display panel according to claim 1, wherein the first substrate is a color filter substrate.

8. The liquid crystal display panel according to claim 1, wherein the second substrate is a thin-film-transistor array substrate.

9. A liquid crystal display panel, comprising:
a first substrate;
a black matrix disposed on the first substrate and defining a plurality of sub-pixels;
a patterned color layer disposed on the sub-pixels;
a patterned transparent layer disposed on the patterned color layer and covering a part of the patterned color layer; and
a second substrate disposed face to face with the first substrate.

10. The liquid crystal display panel according to claim 9, wherein the second substrate further comprises a conductive layer disposed on the patterned color layer and the patterned transparent layer.

11. The liquid crystal display panel according to claim 9, wherein the patterned transparent layer comprises a white color layer.

12. The liquid crystal display panel according to claim 9, wherein the patterned color layer comprises one color of red, green, and blue.

13. The liquid crystal display panel according to claim 9, further comprising a liquid crystal layer disposed between the first substrate and the second substrate.

14. The liquid crystal display panel according to claim 9, wherein the first substrate is a color filter substrate.

15. The liquid crystal display panel according to claim 9, wherein the second substrate is a thin-film-transistor array substrate.

16. The liquid crystal display panel according to claim 9, wherein the sub-pixels comprise a plurality of red, green, blue and white regions.
